(19) United States
(12) Patent Application Publication
(10) Pub. No.: US 2025/0024515 A1
(43) Pub. Date: Jan. 16, 2025

(54) INDICATION OF SYNCHRONIZATION SIGNAL BLOCK TYPE FOR DEVICES WITH REDUCED CAPABILITIES

(71) Applicant: ZTE Corporation, Shenzhen (CN)

(72) Inventor: Li ZHANG, Shenzhen (CN)

(21) Appl. No.: 18/899,371

(22) Filed: Sep. 27, 2024

Related U.S. Application Data
(63) Continuation of application No. PCT/CN2022/112222, filed on Aug. 12, 2022.

(51) Int. Cl. H04W 74/0833; H04W 8/22; H04W 74/08

(52) U.S. Cl. CPC H04W 74/0833; H04W 8/22; H04W 74/0891

(57) ABSTRACT

Methods, apparatus, and systems that relate to indication of Synchronization Signal Block (SSB) types for User Equipment with reduced capabilities are disclosed. In one example aspect, a method for wireless communication includes transmitting, by a base station, system information to a terminal device. The system information indicates whether a cell-defining Synchronization Signal Block (SSB) or a non-cell-defining SSB is applicable to enable the terminal device with reduced capabilities to perform a measurement.

### CROSS REFERENCE TO RELATED APPLICATIONS

This patent document is a continuation of and claims benefit of priority to International Patent Application No. PCT/CN2022/112222, filed on Aug. 12, 2022. The entire content of the before-mentioned patent application is incorporated by reference as part of the disclosure of this application.

### TECHNICAL FIELD

This patent document is directed to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to indication of Synchronization Signal Block (SSB) types for User Equipment with reduced capabilities are disclosed.

In one example aspect, a method for wireless communication includes transmitting, by a base station, system information to a terminal device. The system information indicates whether a cell-defining Synchronization Signal Block (SSB) or a non-cell-defining SSB is applicable to enable the terminal device with reduced capabilities to perform a measurement.

In another example aspect, a method for wireless communication includes receiving, by a terminal device with reduced capabilities, system information from a base station indicating whether a cell-defining Synchronization Signal Block (SSB) or a non-cell-defining SSB is applicable and performing a measurement using the cell-defining SSB or the non-cell-defining SSB based on the system information.

In another example aspect, a method for wireless communication includes receiving, by a base station, information indicating the reduced capabilities of a terminal device in a random-access procedure.

In another example aspect, a method for wireless communication includes transmitting, by a terminal device to a base station, information indicating the reduced capabilities of the terminal device in a random-access procedure.

In another example aspect, a method for wireless communication includes transmitting, from a first node, configuration information about a non-cell-defining Synchronization Signal Block (SSB) to a neighboring node.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates an example time-frequency structure of a Synchronization Signal Block (SSB).

FIG. 2A is a flowchart representation of a method for wireless communication in accordance with one or more embodiments of the present technology.

FIG. 2B is a flowchart representation of another method for wireless communication in accordance with one or more embodiments of the present technology.

FIG. 3A is a flowchart representation of another method for wireless communication in accordance with one or more embodiments of the present technology.

FIG. 3B is a flowchart representation of another method for wireless communication in accordance with one or more embodiments of the present technology.

FIG. 4 is a flowchart representation of yet another method for wireless communication in accordance with one or more embodiments of the present technology.

FIG. 5 shows an example of a wireless communication system where techniques in accordance with one or more embodiments of the present technology can be applied.

FIG. 6 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

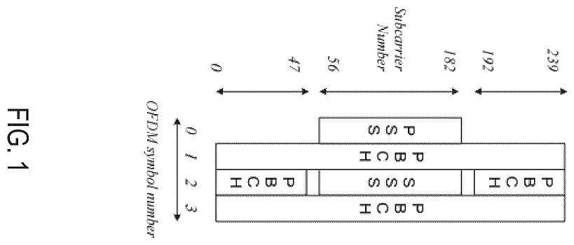

In wireless communications, Synchronization Signal Block (SSB) refers to the Synchronization/Physical Broadcast Channel (PBCH) block that includes the Primary Synchronization Signal (PSS), Secondary Synchronization Signal (SSS), the PBCH Demodulation Reference Signal (DMRS) and the PBCH data. FIG. 1 illustrates an example time-frequency structure of an SSB. The possible time locations of SSBs within a half-frame are determined by sub-carrier spacing and the periodicity of the half-frames where SSBs are transmitted is configured by the network. During a half-frame, different SSBs may be transmitted in different spatial directions (e.g., using different beams, spanning the coverage area of a cell). Within the frequency span of a carrier, multiple SSBs can be transmitted. When an SSB is associated with a Remaining Minimum System Information (RMSI), the SSB is referred to as a Cell-Defining SSB (CD-SSB). The CD-SSB of the Primary Cell (PCell) is always on the synchronization raster. For cell reselection based on intra-frequency measurement, the UE performs measurement based on CD-SSBs located on the synchronization raster. Early measurement is also based on the CD-SSB.

There have been studies identifying features to reduce UE complexity and to allow UEs with reduced capabilities to function efficiently in the communication network. A UE with reduced capabilities is also referred to as a RedCap UE. To enable a RedCE to perform activities such as Radio Link Monitoring (RLM), Bidirectional Forwarding Detection (BFD), and/or serving cell measurement when the active Bandwidth Part (BWP) does not contain CD-SSB, non-cell-defining SSB (NCD-SSB) for RedCap UEs in the connected state (e.g., the Radio Resource Control (RRC) connected state) has been introduced.

Regarding whether NCD-SSB is used for RedCap UE in the non-active states (e.g., RRC idle state or RRC inactive state), a separate initial BWP has been proposed and two schemes have been discussed.

Scheme 1: An idle/inactive RedCap UE camps on a cell associated with CD-SSB and receives paging and system information from the initial DL BWP. Upon access, the RedCap UE switches to the separate RedCap specific initial BWP. This scheme has almost no impact to the current cell selection/reselection procedures. Specifically, the intra-frequency cell reselection remains to be based on the frequency of CD-SSB that the UE is camping on.

Scheme 2: An idle/inactive RedCap UE camps on a cell associated with NCD-SSB, receives paging and performs access using the separate RedCap specific initial BWP. System information is acquired from the initial DL BWP associated with CD-SSB, e.g., upon the system information modification notification.

If the NCD-SSB is configured for RedCap UEs in the non-active state using Scheme 2, the NCD-SSB can be used by the RedCap UEs for intra-frequency/inter-frequency measurements. However, there lacks indication of the different types of SSBs (e.g., CD-SSB, NCD-SSB) to enable the RedCap UEs to properly receive System Information Blocks (SIBs) and function in other procedures. This patent document discloses techniques that can be implemented various embodiments to enable UEs, particularly RedCap UEs, to perform intra-frequency and/or inter-frequency measurement based on NCD-SSB and to indicate the use of NCD-SSB in the RACH procedure. The techniques can also be used by neighboring cells to communication information about the use of NCD-SSB.

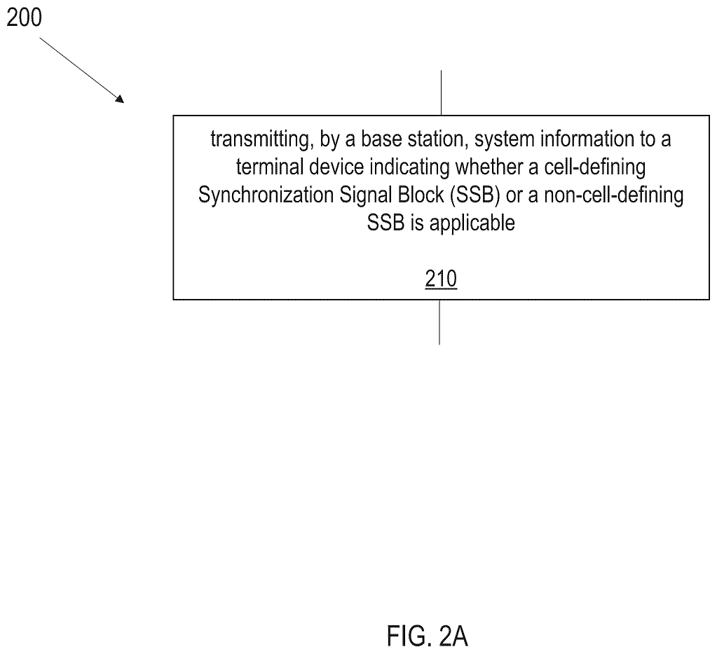

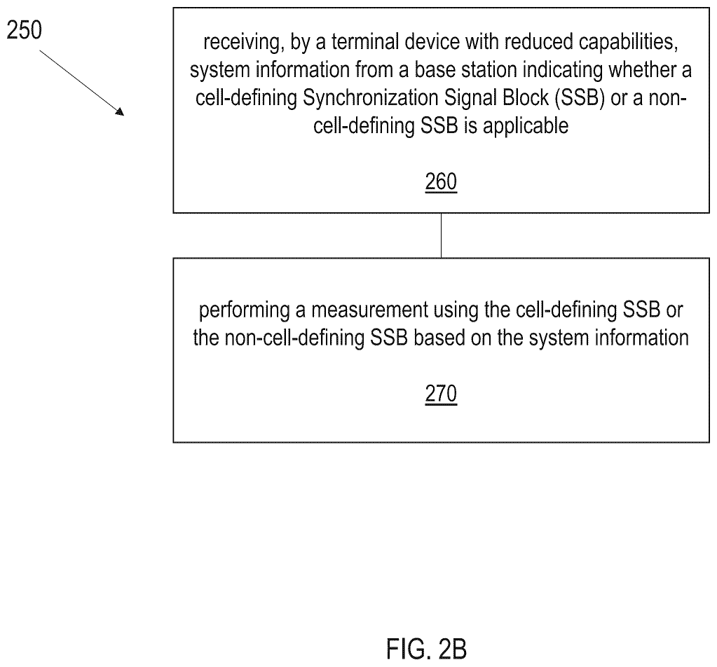

FIG. 2A is a flowchart representation of a method for wireless communication in accordance with one or more embodiments of the present technology. The method 200 includes, at operation 210, transmitting, by a base station, system information to a terminal device. The system information indicates whether a cell-defining Synchronization Signal Block (SSB) or a non-cell-defining SSB is applicable to enable the terminal device with reduced capabilities to perform a measurement.

FIG. 2B is a flowchart representation of a method for wireless communication in accordance with one or more embodiments of the present technology. The method 250 includes, at operation 260, receiving, by a terminal device with reduced capabilities, system information from a base station indicating whether a cell-defining Synchronization Signal Block (SSB) or a non-cell-defining SSB is applicable. The method 250 also includes, at operation 270, performing a measurement using the cell-defining SSB or the non-cell-defining SSB based on the system information.

In some embodiments, the system information is carried in a System Information Block (SIB) for intra-frequency measurement. In some embodiments, the system information is carried in a SIB for inter-frequency measurement. In some embodiments, in response to the non-cell-defining SSB being applicable, the non-cell-defining SSB is associated with cell group resources.

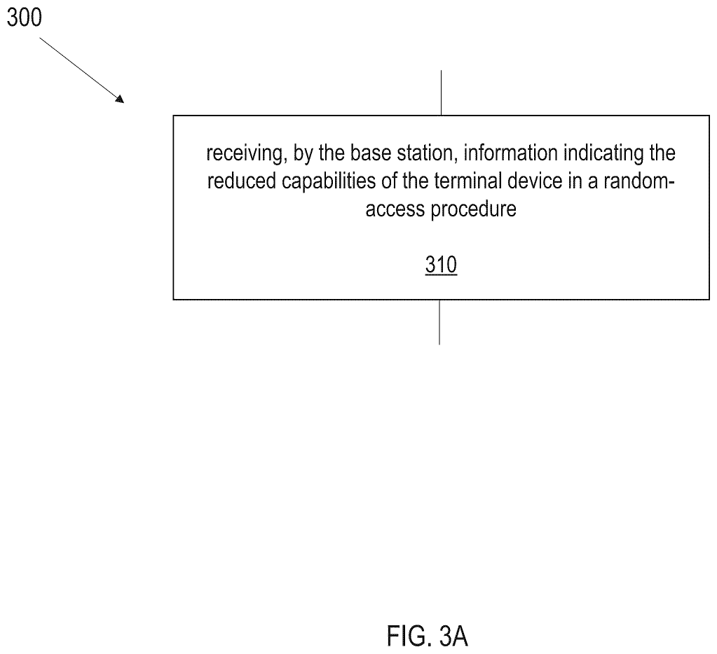

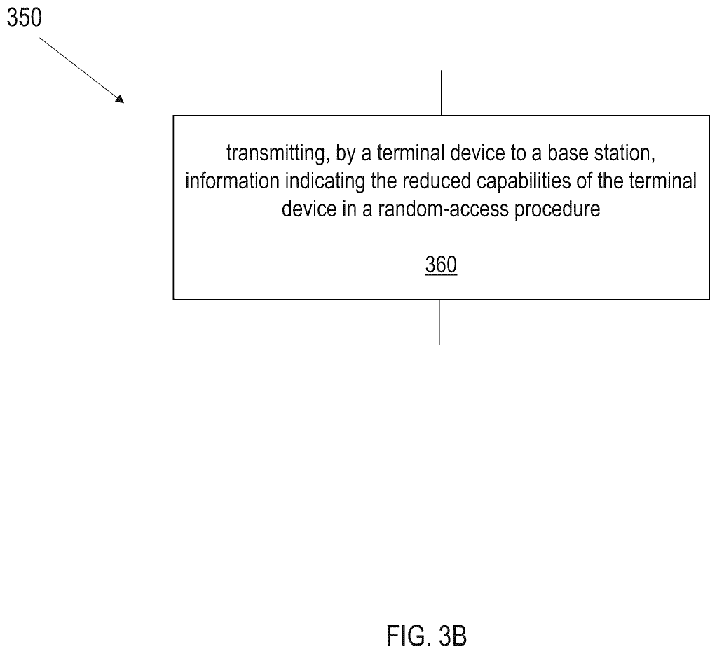

FIG. 3A is a flowchart representation of a method for wireless communication in accordance with one or more embodiments of the present technology. The method 300 includes, at operation 310, receiving, by the base station, information indicating the reduced capabilities of the terminal device in a random-access procedure.

FIG. 3B is a flowchart representation of a method for wireless communication in accordance with one or more embodiments of the present technology. The method 350 includes, at operation 360, transmitting, by a terminal device to a base station, information indicating the reduced capabilities of the terminal device in a random-access procedure.

In some embodiments, usage of a dedicated resource for a Msg1 of the random-access procedure indicates reduced capabilities of the terminal device. In some embodiments, the information indicating the reduced capabilities is defined in a feature combination information element.

In some embodiments, the information indicating the reduced capabilities is carried in a Msg3 of the random-access procedure. For example, the information indicating the reduced capabilities can be carried in a logical channel identifier value of the Msg3.

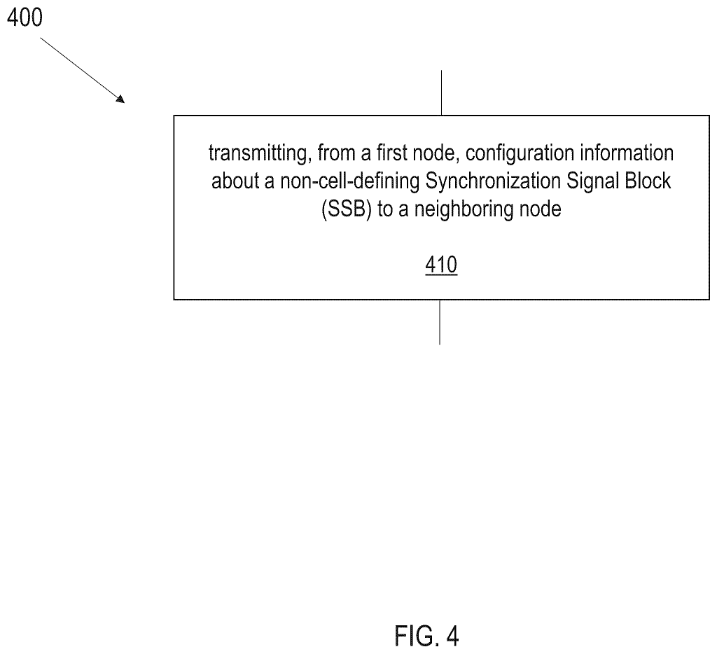

FIG. 4 is a flowchart representation of a method for wireless communication in accordance with one or more embodiments of the present technology. The method 400 includes, at operation 410, transmitting, from a first node, configuration information about a non-cell-defining Synchronization Signal Block (SSB) to a neighboring node.

In some embodiments, the configuration information comprises at least one of: a carrier frequency for the non-cell-defining SSB, or SSB type. In some embodiments, the configuration information is carried in at least one of: an access node configuration update acknowledge message, a Xn setup response message, or a Xn setup request message.

Some examples of the disclosed techniques are further described below.

### Embodiment 1

If the NCD-SSB is configured for RedCap UEs in the non-active state using Scheme 2, both CD-SSB and NCD-SSB can be configured in neighboring cells for cell selection. Neighboring cell measurement thus can be performed based on CD-SSB and/or NCD-SSB. Proper indication of the SSB type (e.g., CD-SSB or NCD-SSB) is needed to allow the RedCap UEs to perform neighboring cell measurement accordingly. Furthermore, when a cell is selected based on measurement results and/or cell reselection rules, if NCD-SSB is used for the measurement, the UE needs to switch to CD-SSB ARFCN to receive SIBs properly. Therefore, the type of SSB (e.g., CD-SSB or NCD-SSB) needs to be indicated to the UE along with the CD-SSB ARFCN.

Currently, the UE performs intra-frequency measurement based on CD-SSBs located on the synchronization raster for cell reselection. When NCD-SSB is introduced for RedCap UE in RRC_IDLE/RRC_INACTIVE state, NCD-SSB in the separate initial DL BWP can be used for intra-frequency measurement. In some embodiments, NCD-SSB is configured in some neighboring cells such that either NCD-SSB or CD-SSB can be used for cell reselection measurement.

In NR communication systems, System Information Block 3 (SIB3) provides neighboring cell information relevant for intra-frequency cell re-selections, including cells with specific re-selection parameters and blacklisted cells information. Therefore, SSB type that is related to the intra-frequency measurement can be included in SIB3. Table 1 shows an example configuration information that can be included in SIB3.

TABLE 1

SSBType CHOICE {
cd-SSB NULL,
ncd-SSB NULL
} OPTIONAL,
cd-SSB-Frequency ARFCN-ValueNR OPTIONAL, -- Need R

The UE also performs inter-frequency measurement based on CD-SSBs located on the synchronization raster for cell reselection. In NR communication systems, System Information Block 4 (SIB4) provides information relevant for inter-frequency cell re-selections, including information about other NR frequencies and inter-frequency neighboring cells relevant for cell re-selection. It also includes cell re-selection parameters common for a frequency as well as cell specific re-selection parameters. Therefore, SSB type that is related to the inter-frequency measurement can be included in SIB4. Table 2 shows an example configuration information that can be included in SIB4.

TABLE 2

SSBType CHOICE {
cd-SSB NULL,
ncd-SSB NULL
} OPTIONAL,
cd-SSB-Frequency ARFCN-ValueNR OPTIONAL, -- Need R

### Embodiment 2

When the CD-SSB is used for intra-frequency measurement, inter-frequency measurement, and/or early measurement, neighboring cell information can be exchanged via inter-node messages. For example, CD-SSB can be carried in the MeasurementTimingConfiguration message, which is used to convey assistance information for measurement timing.

When NCD-SSB is configured for intra-frequency measurement, inter-frequency measurement, and/or early measurement, NCD-SSB related information also needs to be exchanged among the current serving cell and/or camped cell. The NCD-SSB related information includes at least one of NCD-SSB ARFCN, a period, and/or a time offset. Table 3 shows an example of NCD-SSB information that can be carried in an inter-node message (e.g., the MeasurementTimingConfiguration message).

TABLE 3

MeasTiming ::= SEQUENCE
frequencyAndTiming SEQUENCE {
carrierFreq ARFCN-ValueNR,
ssbSubcarrierSpacing SubcarrierSpacing,
ssb-MeasurementTimingConfiguration SSB-MTC,
ss-RSSI-Measurement SS-RSSI-Measurement OPTIONAL
} OPTIONAL,
FrequencyAndTimingForNcd-ssb SEQUENCE {
carrierFreqForNcd-ssb ARFCN-ValueNR,
ncd-ssb-MeasurementTimingConfiguration SSB-MTC,
} OPTIONAL,
...,
[[
ssb-ToMeasure SSB-ToMeasure OPTIONAL,
physCellId PhysCellId OPTIONAL
]]
}

The NCD-SSB related information can be carried in inter-node messages that are exchanged between the neighboring nodes. In particular, the Xn interface supports the exchange of signaling information between two radio access nodes (RANs). For example, NCB-SBB related information can be carried (e.g., via the MeasurementTimingConfiguration) in RAN Node Configuration Update Acknowledge message, Xn Setup Response message, Xn Setup Request message, other existing or new message(s) on the Xn interface.

### Embodiment 3

Currently, for Small Data Transmission (SDT) procedure based on Configured Grant (CG), CD-SSB is the SSB associated with the CG resource(s). If NCD-SSB is configured in the separate initial DL BWP corresponding to the initial UL BWP configured with CG resource according to Scheme 2 discussed above, proper indication is needed to show that NCD-SSB is the SSB associated with CG resource(s).

In some embodiments, small data can be transmitted via CG resource(s) in the RRC inactive state when certain conditions are satisfied (e.g., SSB measurement exceeds a threshold). Currently, only CD-SSB can be the SSB associated with the CG resource(s). When NCD-SSB is configured in the separate initial DL BWP that corresponds to the initial BWP configured for the CG resource(s), the NCD-SSB becomes the SSB associated with CG resource(s).

### Embodiment 4

In the Random-Access (RACH) procedure, the NCD-SSB can be configured in the separate initial DL BWP that corresponds to the initial UL BWP configured with RACH common resource. Proper indication is needed to show that NCD-SSB is the SSB associated with RACH occasions.

In order to minimize impact on existing UEs (e.g., non-RedCap UEs and/or legacy UEs with reduced capabilities), early identification of RedCap UE is needed in the RACH procedure (e.g., when the Physical Downlink Shared Channel (PDSCH) decoding time N1 and/or the Physical Uplink Shared Channel (PUSCH) preparing time N2 are relaxed). Furthermore, for RedCap UEs, a single UE type can be used in identification/indication to further reduce complexity. In some embodiments, early identification of the new generation of RedCap UEs can be included in the RACH procedure messaging, such as Msg1 and/or Msg3. Some examples of Msg1 and/or Msg3 with RedCap UE identification are described below.

Example 1: Msg1 based early identification of RedCap UEs. In this example, usage of early RedCap UE identification in Msg1 (e.g., in the 4-step RACH procedure) or MSGA (e.g., in the 2-step RACH procedure) can be implicitly indicated by the presence of dedicated RACH configuration or usage of dedicated RACH resource(s). For example, the dedicated RACH configuration associated with RedCap UEs being present in Msg1 indicates that the RACH resource is used by a RedCap UE. That is, the RedCap UE selects a dedicated RACH resource to transmit the preamble so as to allow the base station to know that it is a RedCap UE. In some embodiments, there is an indication indicating whether the RACH resource can be used by RedCap UE.

In some embodiments, a reserved/spared bit in the FeatureCombination Information Element (IE) of UE capabilities can be used to provide an indication of RedCap UE. Table 4 shows an example of RedCap UE indication in the FeatureCombination IE.

TABLE 4
FeatureCombination-r17 ::= SEQUENCE {

| | | |
|---|---|---|
| redCap-r17 | ENUMERATED {true} | OPTIONAL, -- Need R |
| smallData-r17 | ENUMERATED {true} | OPTIONAL, -- Need R |
| nsag-r17 | NSAGList-r17 | OPTIONAL, -- Need R |
| msg3-Repetitions-r17 | ENUMERATED {true} | OPTIONAL, -- Need R |
| eRedCap-r18 | ENUMERATED {true} | OPTIONAL, -- Need R |
| spare3 | ENUMERATED {true} | OPTIONAL, -- Need R |
| spare2 | ENUMERATED {true} | OPTIONAL, -- Need R |
| spare1 | ENUMERATED {true} | OPTIONAL -- Need R |

}

Example 2: Msg3 based early identification of RedCap UEs. In this example, usage of early RedCap UE identification can be included in the Msg 3 of the RACH procedure. For example, as shown in Table 5, when the Msg3 includes the Common Control Channel (CCCH) data, the dedicated Logical Channel Identifier (LCID) can include values identifying the RedCap UEs.

TABLE 5

| Codepoint/ | |
|---|---|
| Index | LCID values |
| 0 | CCCH of size 64 bits (referred to as “CCCH1” in |
| | TS 38.331 [5]), except for a RedCap UE |
| 1-32 | Identity of the logical channel of DCCH and DTCH |
| 33 | Extended logical channel ID field (two-octet eLCID |
| | field) |
| 34 | Extended logical channel ID field (one-octet eLCID |
| | field) |
| 35 | CCCH of size 48 bits (referred to as “CCCH” in |
| | TS 38.331 [5]) for a RedCap UE |
| 36 | CCCH1 of size 64 bits (referred to as “CCCH1” in |
| | TS 38.331 [5]) for a RedCap UE |
| 37 | CCCH of size 48 bits for an eRedCap or Rel-18 |
| | RedCap UE |
| 38 | CCCH1 of size 64 bits for an eRedCap or Rel-18 |
| | RedCap UE |
| 39-43 | Reserved |

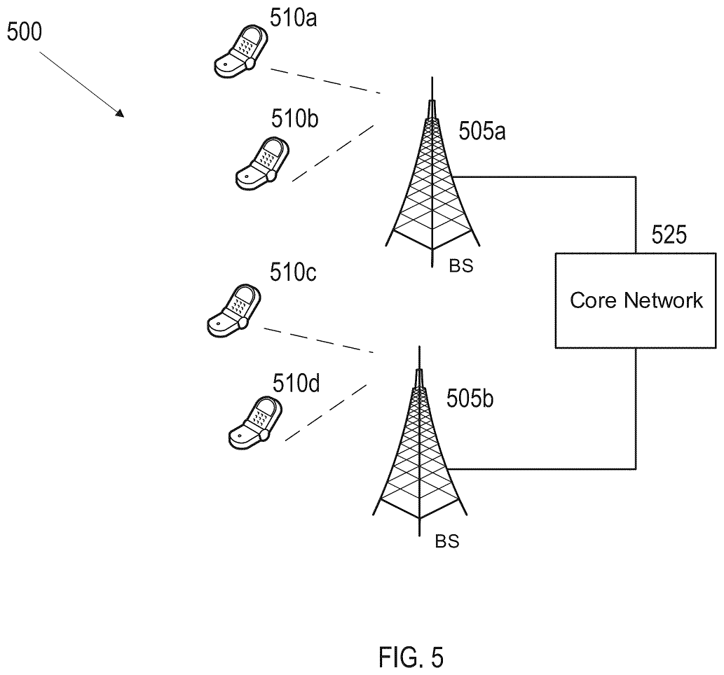

FIG. 5 shows an example of a wireless communication system 500 where techniques in accordance with one or more embodiments of the present technology can be applied. A wireless communication system 500 can include one or more base stations (BSs) 505a, 505b, one or more wireless devices (or UEs) 510a, 510b, 510c, 510d, and a core network 525. A base station 505a, 505b can provide wireless service to user devices 510a, 510b, 510c and 510d in one or more wireless sectors. In some implementations, a base station 505a, 505b includes directional antennas to produce two or more directional beams to provide wireless coverage in different sectors. The core network 525 can communicate with one or more base stations 505a, 505b. The core network 525 provides connectivity with other wireless communication systems and wired communication systems. The core network may include one or more service subscription databases to store information related to the subscribed user devices or terminal devices 510a, 510b, 510c, and 510d. A first base station 505a can provide wireless service based on a first radio access technology, whereas a second base station 505b can provide wireless service based on a second radio access technology. The base stations 505a and 505b may be co-located or may be separately installed in the field according to the deployment scenario. The user devices 510a, 510b, 510c, and 510d can support multiple different radio access technologies. The techniques and embodiments described in the present document may be implemented by the base stations of wireless devices described in the present document.

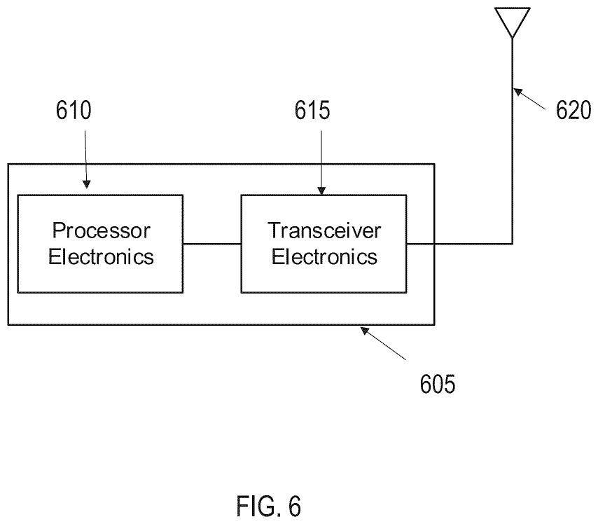

FIG. 6 is a block diagram representation of a portion of a radio station in accordance with one or more embodiments of the present technology can be applied. A radio station 605 such as a network node, a base station, or a wireless device (or a user device, UE) can include processor electronics 610 such as a microprocessor that implements one or more of the wireless techniques presented in this document. The radio station 605 can include transceiver electronics 615 to send and/or receive wireless signals over one or more communication interfaces such as antenna 620. The radio station 605 can include other communication interfaces for transmitting and receiving data. Radio station 605 can include one or more memories (not explicitly shown) configured to store information such as data and/or instructions. In some implementations, the processor electronics 610 can include at least a portion of the transceiver electronics 615. In some embodiments, at least some of the disclosed techniques, modules or functions are implemented using the radio station 605. In some embodiments, the radio station 605 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
receiving, by a base station, information indicating reduced capabilities of a terminal device in a random-access procedure,
wherein the information indicating the reduced capabilities of the terminal device is indicated by a logical channel identifier of a Msg3 of the random-access procedure.

2. The method of claim 1, wherein the information indicating the reduced capabilities of the terminal device is indicated by usage of a dedicated resource for a Msg1 of the random-access procedure.

3. The method of claim 2, wherein the information indicating the reduced capabilities is defined in a feature combination information element.

4. A method for wireless communication, comprising:
transmitting, by a terminal device to a base station, information indicating reduced capabilities of the terminal device in a random-access procedure,
wherein the information indicating the reduced capabilities of the terminal device is indicated by a logical channel identifier of a Msg3 of the random-access procedure.

5. The method of claim 4, wherein the information indicating the reduced capabilities of the terminal device is indicated by usage of a dedicated resource for a Msg1 of the random-access procedure.

6. The method of claim 5, wherein the information indicating the reduced capabilities is defined in a feature combination information element.

7. A communication apparatus, comprising at least a processor configured to cause the communication apparatus to:
receive information indicating reduced capabilities of a terminal device in a random-access procedure,
wherein the information indicating the reduced capabilities of the terminal device is indicated by a logical channel identifier of a Msg3 of the random-access procedure.

8. The communication apparatus of claim 7, wherein the information indicating the reduced capabilities of the terminal device is indicated by usage of a dedicated resource for a Msg1 of the random-access procedure.

9. The communication apparatus of claim 8, wherein the information indicating the reduced capabilities is defined in a feature combination information element.

10. A communication apparatus, comprising at least a processor configured to cause the communication apparatus to:
transmit, to a base station, information indicating reduced capabilities of the communication apparatus in a random-access procedure,
wherein the information indicating the reduced capabilities of the communication apparatus is indicated by a logical channel identifier of a Msg3 of the random-access procedure.

11. The communication apparatus of claim 10, wherein the information indicating the reduced capabilities of the communication apparatus is indicated by usage of a dedicated resource for a Msg1 of the random-access procedure.

12. The communication apparatus of claim 11, wherein the information indicating the reduced capabilities is defined in a feature combination information element.

13. A non-transitory, computer-readable storage medium comprising instructions recorded thereon, wherein the instructions, when executed by at least one data processor of a communication device, cause the communication device to implement the method of claim 1.

14. The non-transitory, computer-readable storage medium of claim 13, wherein the information indicating the reduced capabilities of the terminal device is indicated by usage of a dedicated resource for a Msg1 of the random-access procedure.

15. The non-transitory, computer-readable storage medium of claim 14, wherein the information indicating the reduced capabilities is defined in a feature combination information element.

16. A non-transitory, computer-readable storage medium comprising instructions recorded thereon, wherein the instructions, when executed by at least one data processor of a communication device, cause the communication device to implement the method of claim 4.

17. The non-transitory, computer-readable storage medium of claim 16, wherein the information indicating the reduced capabilities of the terminal device is indicated by usage of a dedicated resource for a Msg1 of the random-access procedure.

18. The non-transitory, computer-readable storage medium of claim 17, wherein the information indicating the reduced capabilities is defined in a feature combination information element.
